(19) United States
(12) Patent Application Publication
(10) Pub. No.: US 2013/0256478 A1
(43) Pub. Date: Oct. 3, 2013

(54) Mounting arm for tablet computer

(71) Applicants: Ronald F. Reda, Orlando Park, FL (US); David Newman, Highland Park, IL (US)

(72) Inventors: Ronald F. Reda, Orlando Park, FL (US); David Newman, Highland Park, IL (US)

(21) Appl. No.: 13/506,166

(22) Filed: Apr. 2, 2012

(51) Int. Cl. B60R 11/02; F16M 13/02

(52) U.S. Cl. CPC B60R 11/02; F16M 13/022
USPC 248/205.1; 224/275

(57) ABSTRACT

A mounting arm is provided for mounting electronic components such as a tablet computer in a manner which allows for multiple electronic components to be mounted to a single mounting arm which is attached to a headrest of a vehicle. Extension arms are provided to the main mounting arm which are flexible and allow for the orientation of the electronic components in multiple orientations within a vehicle, so that occupants in the vehicle may manipulate the extension arm in multiple ranges for easy viewing for occupants in the front and rear positions of the vehicle.

This application claims priority to provisional application no. 61/516,110 filed Mar. 30, 2011

### TECHNICAL FIELD

The present invention pertains to a mounting arm and in particular an arm to support an electronic component thereon and to provide for mounting of the arm securely to a surface.

### BACKGROUND

Portable components are useful when they can be carried with a person, used in their home or used in an automobile. However, such components can be easily tampered with by strangers or children and also when not secured, can provide a risk of damage to the component itself by falling or when used in an automobile may become a projectile if not properly secured. For example, electronic components such tablet computers including the iPad manufactured by Apple Computer and Xoom manufactured by Motorola; and DVD (Digital Video Disc) players are easily obtained today in small portable sizes. Such players are useful because they can be used in any situation, including in the home, while traveling on an airplane or in an automobile. However, such electronic components are usually fairly expensive and need to be cared for so that they do not fall and get damaged, cannot be touched by children and do not become a projectile in a moving vehicle. Therefore, there is desired a securement means for securing components such as electronic components in a quick and easy manner to a base support that is securely mounted to a surface so that the electronic component cannot be tampered with, dropped or become a projectile in a moving vehicle.

A prior art mounting arm device described in U.S. Pat. No. 7,111,814, incorporated herein by reference, is, in part, depicted in FIG. 1. The mounting arm includes a base or platform 10 having a mounting or support area 20 for receiving an electronic component 30 thereon. FIG. 1 depicts a DVD (Digital Video Disc) player 30. The mounting area 20 includes a ridge 25 surrounding the mounting surface. In an embodiment, the base 10 and ridge 25 are integrally molded of a polymer material such as polypropylene or other hard plastics. In another embodiment, the ridge 25 may be formed of a softer polymer material such as santoprene so that electrical cords 35 exiting from the electronic component may be engaged in the soft material of the ridge 25 so that a depression 36 is formed in order to cradle the plug 38 and act as a strain relief for the cord 35 and plug 38. In an embodiment, the ridge 25 may surround the mounting area 20 on all four sides. In an alternate embodiment, the mounting arm 1 may be formed of wood or other composite.

In an embodiment, the platform 10 also includes holes 39 formed therein in to receive electrical cords or cables 35 therethrough. The cords 35 may be routed through the holes 39 to the underside of the platform 10 so that they do not clutter-up the working area on the top side of the platform 10. Also provided on the top side and underside of the platform 10, in an embodiment, are loops 40, 41, 42 that clamp onto and route the cables or wires 35, 44 along the platform 10. In an embodiment, cable 35 may provide power and connect to a power outlet or cigarette lighter of a vehicle. In an embodiment, wire 44 may provide audio output and connect to an earbud or headset for a passenger of a vehicle to listen to the electronic component 30. The loops 40, 41, 42 and holes 39 combine to provide a cable management system that maintains the electronic component in a safe and easy to use environment.

The base or platform 10 has an arm 50 attached thereto. In an embodiment, the arm 50 may be integrally molded to the platform 10 via bend 53. In other embodiments, the arm 50 may be attached with fasteners including screws, brackets, adhesives or hinges. The arm 50 includes mounting apertures 51, 52 formed at its terminal end. In an embodiment, the mounting apertures 51, 52 receive a rod or rods 61, 62 of the clamping member, upright member or head rest 65 of the vehicle there through. The rods 61, 62 extend through the mounting apertures 51, 52 into receptacles 68, 69 of the top of the support surface or seat back 70. For example, FIG. 1 illustrates the top of the seat back 70 (e.g. a driver's seat) of a vehicle such as an automobile, viewed from the rear, facing toward the front of the car. In an embodiment, the rods 61, 62 have serrations formed thereon so that the clamping member 65 is adjustable and may lock in place so that its lower clamping surface 72 abuts against the top planar surface 73 of the arm 50 so that it captures the arm 50 and clamps it between the bottom clamping surface 72 and the top of the support surface 70. In an alternate embodiment, the rods 61, 62 may be a single flat bar or other vertical structure. The mounting arm 1 may be used in environments other than a vehicle, for example in a home, business or outdoors. The arm 1 can be mounted to any support surface having a vertical member protruding from an upright member.

The base or platform 10 further includes an attachment member 80 which is secured to the platform 10 and helps to securely attach the electronic component to the base 10. In an embodiment, the attachment member 80 may include elastic straps having hook and loop fasteners, such as a pair of Velcro straps 81, 82 that are attached at both sides of the mounting surface 20. The straps 81, 82 may be secured to the mounting area, for example by fasteners, adhesive or insert molding. The straps 81, 82 may be placed over the electronic component 30 by stretching the resilient, elastic straps 81, 82 to an extended position. In an embodiment, the straps 81, 82 may be stretched tightly so that the ends having Velcro straps 83, 84 are fastened to each other in order to securely hold the electronic component 30 thereto. However, other types of attachment members may provided, such as clips, clamps or fingers in order to clamp the edges of the electronic component 30 to the mounting area 20 or ropes, strings or bungee cords may be attached to the platform 10 and resiliently placed around the electronic component 30.

In an embodiment, the straps 81, 82 may include compression or offset members 85, 86 such as rubber sleeves that are slid onto the straps 81, 82. The offset members 85, 86 provide an offset between the strap 81, 82 and the top surface of the electronic component 30. The electronic component includes buttons 88 that control the operation of the electronic component 30. For example, the button 88 may be the play, rewind, fast-forward or stop button to control the operation of a DVD. In order to prevent the straps 81, 82 from pushing down and activating the buttons 88 when the straps 81, 82 are pulled taught over the top of the electronic component 30, offset members 85, 86 are adjusted by sliding along the straps 81, 82 so that the offset members 85, 86 are adjacent the buttons 88 and the strap 81, 82 is elevated slightly above the surface of the electronic component at the area near the buttons 88. Although the straps 81, 82 are elevated above the top surface of the electronic component, the offset members 85, 86 still transfer the compression or gripping force of the straps 81, 82 to the electronic component 30 in order to securely hold the electronic component 30 to the platform 10.

A rim may be positioned to abut against the edge of the electronic component 30 mounted on the platform 10. Thus, the electronic component 30 is captured between the ridge 25 on one side and the adjustable rim on the other side so that the X-Y or lateral movement of the electronic component 30 is restricted by the rim and ridge 25. In an embodiment, the ridge 25 may surround the mounting area 20 on at least three sides so that lateral movement is restricted in all directions. Vertical movement or movement in the Z axis is restricted by the attachment members 81, 82 placed around the electronic component 30. As additional means of restricting movement of the electronic component 30, to insure that it cannot come loose during high speed deceleration, attachment members 97, 98 such as Velcro straps may be mounted on the mounting area 20 with adhesive. Corresponding straps can be secured to the bottom of the electronic component 30 in order so that the attachment members, hooks or loops can engage one another on each side of the Velcro straps in order to provide additional retention means. In an embodiment, the platform 10 may have a tray 102 formed underneath for storage of articles such as DVD storage jewel boxes or a remote control device for a DVD player. The arm 50 also may include a stabilizing member 104. In an embodiment, the stabilizing member 104 is a U-shaped clip that is attached to the arm 50 generally at a midpoint and each of the arms clamp onto the sides of the support surface or seat back 70. In an embodiment, the stabilizer may be integrally molded with the arm 50 or attached to the arm 50 with fasteners such as screws.

Such prior art devices do not provide for mounting of multiple electronic devices simultaneously. The present invention improves on prior art devices.

### SUMMARY

In an embodiment the invention provides for an arm for mounting electronic components comprising an arm including a mounting aperture, a support area for receiving the electronic component thereon, a junction member attached to the arm, a plurality of extension arms extending from the junction member, an attachment member for fastening at least a portion of the electronic component to the support area and an upright member having a rod that mounts to a support surface, and a rod of the upright member is inserted through the mounting aperture in order to mount the base to the support surface. In an embodiment the retention arm includes at least three attachment points.

In a further embodiment, a mounting apparatus is provided comprising a support area, an arm attached to the support area, the arm having a clamping member having an opening on a side and a support surface having a rod protruding therefrom and the arm supported by the support surface and the mounting aperture for receiving the rod through the open side and received within the aperture.

In another embodiment a mounting apparatus is provided that includes an arm supported on a support surface, a platform attached to the arm for receiving an electronic component thereon and a slidable sleeve received in a mounting bracket for attaching the arm to the platform.

### BRIEF DESCRIPTION OF THE FIGURES

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of a prior art mounting arm of the present invention mounted to a vehicle's seatback having an electronic component attached thereon;

FIG. 2 is a perspective view of the mounting arm of the present invention;

FIG. 3 is an exploded perspective view of the mounting arm of FIG. 2;

FIG. 4 is an exploded perspective view of an alternate embodiment of a mounting arm of the present invention;

FIG. 5 is a perspective view of another alternate embodiment of the mounting arm of the present invention;

FIG. 6 is a perspective view of the mounting arm of FIG. 5, having an electronic component mounted thereto;

FIG. 7 is an enlarged perspective view of the mounting bracket on the back side of the platform of the mounting arm of FIG. 6;

FIG. 8 is an enlarged perspective view of an alternate embodiment of a mounting bracket on the back side of the platform of the mounting arm of FIG. 6;

FIG. 9 is an enlarged perspective view of the junction member of FIG. 4;

FIG. 10 is a perspective view of an alternate embodiment of a mounting arm of the present invention;

FIG. 11-13 is a perspective view a further alternate embodiment of a mounting arm of the present invention; and

FIG. 14 is a perspective view of an accessory for use with the mounting arm of the present invention.

FIG. 15 is a perspective view of a main mounting arm of an alternate embodiment of the present invention.

FIG. 16 is a plan view of an alternate embodiment of a mounting bracket of the present invention.

FIG. 17 is a perspective cut away view of the bracket of FIG. 16;

FIG. 18 is a plan view of the bracket of FIG. 17;

FIG. 19 is a cut away view of FIG. 18 taken at line 19-19; and

FIG. 20 is a similar view of the bracket of FIG. 19 shown with a sleeve of an extension arm inserted therein.

### DETAILED DESCRIPTION

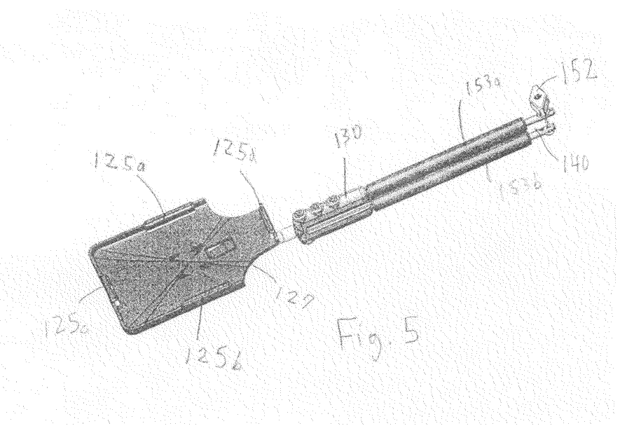

Embodiments of a mounting arm 100 of the present invention are depicted with respect to FIGS. 2-10. Although each FIG. depicts various embodiments of the invention, like numerals identify like elements of all of the FIGS. A main mounting arm 100 is attached to a base or plate 110 that has a mounting or support area 112 for receiving an electronic component 115 thereon (FIG. 4). An extension arm 120a, b, c, d, e is attached between the main arm 100 and plate 110, FIG. 4 depicts an iPad tablet computer 115 mounted to the support area 112. However, the present invention can be used to secure all types of components such as navigation systems, portable radios, lap-top computers, tablet computers, credit card swiping devices, personal digital assistants, DVD (Digital Video Disc) players or other portable devices.

The support area 112 includes a retention members 125a,b surrounding the mounting surface. In an embodiment, the base 110 and retention members 125 are integrally molded of a polymer material such as polypropylene or other hard plastics. In an embodiment, the retention members 125a,b may surround the mounting area 112 on all four sides, on three sides, on two sides, in four corners, or in two corners. In an alternate embodiment, the mounting arm 1 may be formed of metal or other composite.

In an embodiment, the plate 110 also includes holes or cut-out portions 127 formed to receive electrical cords or cables therethrough. In an embodiment, cable may provide power and connect to a power outlet or cigarette lighter of a vehicle. In an embodiment, wire may provide audio output and connect to an earbud or headset for a passenger of a vehicle to listen to the electronic component 115.

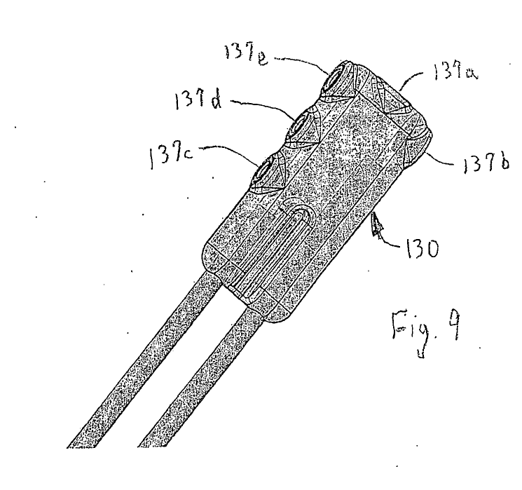

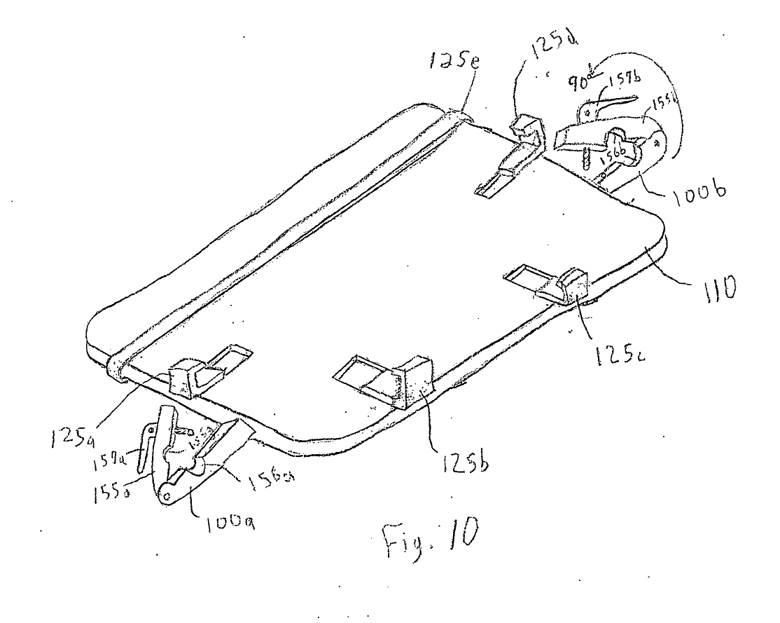

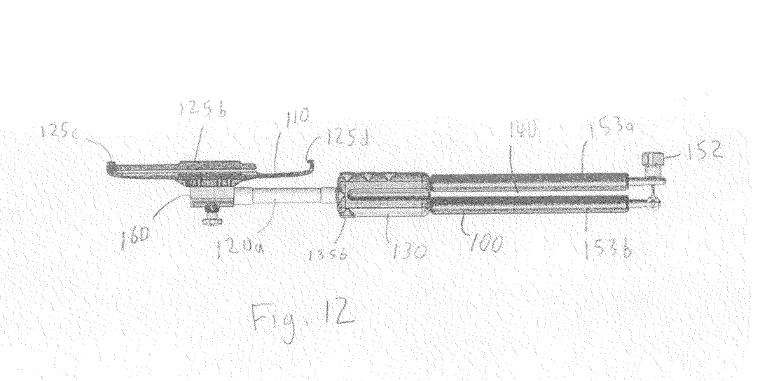

The base or plate 110 has extension arms 120a,b,c,d,e attached thereto. In an embodiment, the arms 120 may be integrally molded to the plate 110 or attached via a snap-fit or screwed in place. In other embodiments, the arms 120 may be attached with fasteners including screws, brackets, adhesives or hinges. As will be discussed further below, the arms 120 may be interchangeable in the different locations on the main arm 100. The main arm 100 includes a junction member 130 having mounting points 135a,b,c,d,e. In an embodiment, the mounting points may have female receptacles 137a,b,c,d,e (FIG. 9) to which the arms 120a,b,c,d,e, respectively are mounted. In an embodiment the female receptacle is a ball socket for receiving a male ferrule 139a,b,c,d,e of the arm to be snap-fit therein. This connection is similar to any adjusting sliding pole system where a pole slides within another pole and then can be locked into position via the button pultruding through aligning holes in the two poles now locking them together and Thus, it may be understood, that in the embodiment depicted there are five mounting points. In an embodiment, a single arm 120 may be provided that can be mated at all five mounting points 135a,b,c,d,e (FIG. 11). In another embodiment, an assortment of different length extension arms 120 may be provided to be mated to each mounting point 135a,b,c,d,e. For example the extension arms may be provided in lengths of 4″, 6″, 8″. 10″, 12″, 14″ and 16″. The extension arms 120 are preferably flexible arms formed of metal coils, such as snake arms or goosenecks.

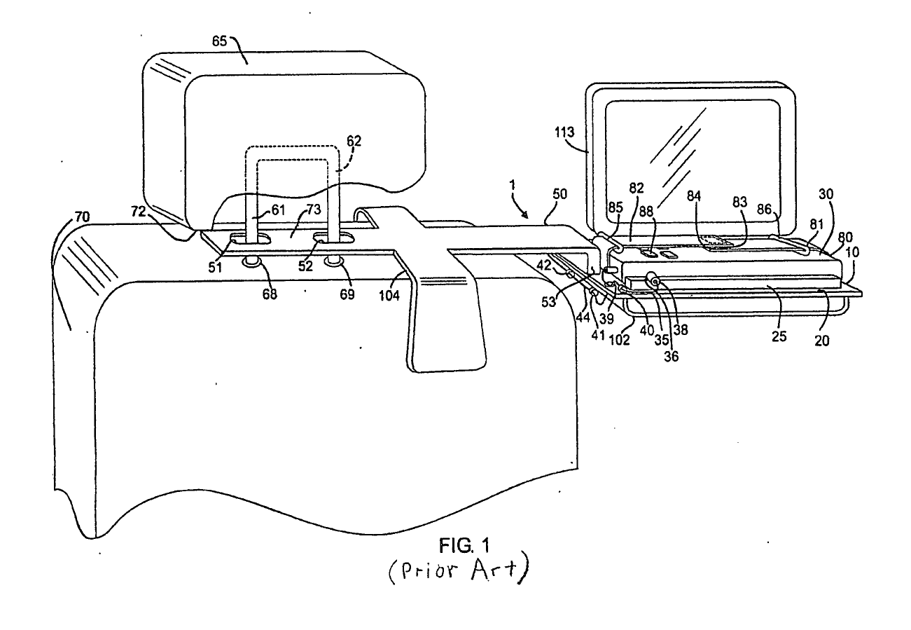

The arm 100 includes a mounting aperture 140 (FIG. 2) provided longitudinally along its centerline. In an embodiment, the mounting aperture 140 receives a rod or rods 61, 62 of the clamping member, upright member or head rest 65 of the vehicle there through (FIG. 1). The rods 61, 62 extend through the mounting aperture 140 into receptacles 68, 69 of the top of the support surface or seat back 70. For example, FIG. 1 illustrates the top of the seat back 70 (e.g. a driver's seat) of a vehicle such as an automobile, viewed from the rear, facing toward the front of the car. In an embodiment, the rods 61, 62 have serrations formed thereon so that the clamping member 65 is adjustable and may lock in place so that its lower clamping surface 72 abuts against the top planar surface 73 of the arm 100 so that it captures the arm 100 and clamps it between the bottom clamping surface 72 and the top of the support surface 70. In an alternate embodiment, the rods 61, 62 may be a single flat bar or other vertical structure. The mounting arm 100 also may be used in environments other than a vehicle, for example in a home, business or outdoors. The arm 100 can be mounted to any support surface having a vertical member protruding from an upright member.

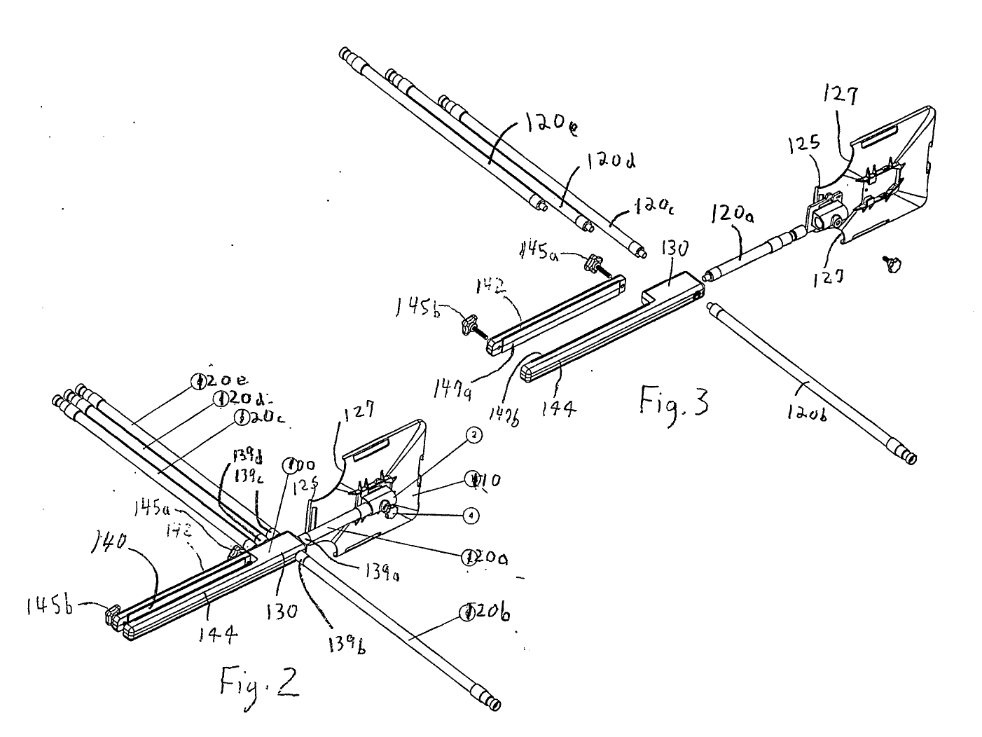

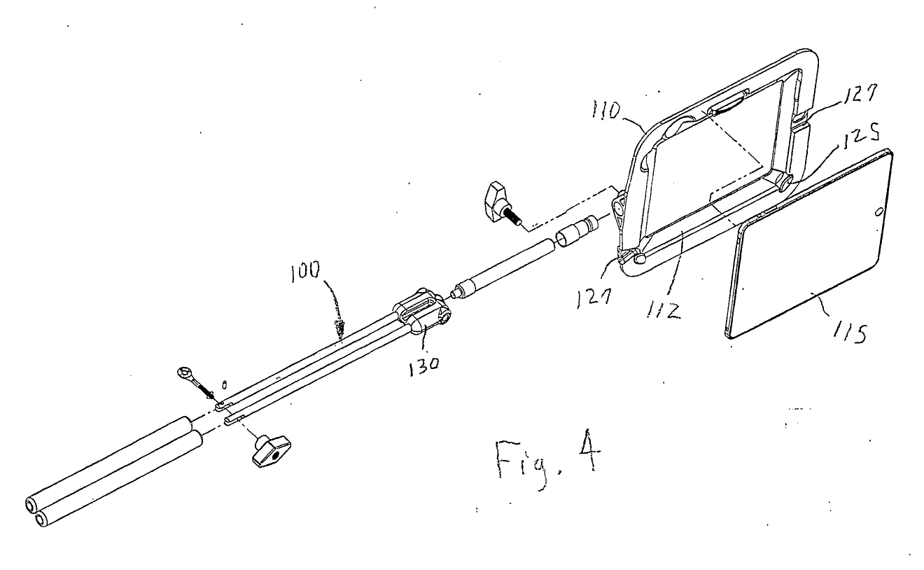

In an embodiment as shown in FIG. 2-3, the aperture 140 is formed when a clamping member 142 is mounted to a stationary beam 144 of the main arm 100. The clamping member 142 may be secured to the stationary beam 144 via fasteners, such as thumb screws 145a,b which are threadably attached to the stationary beam 144. Once the stationary beam 144 is placed next to the rods of a headrest, the clamping member 142 may be place on the opposite sides of the rods of the headrest and by tightening the thumb screws 145a,b the main arm 100 may be securely mounted to the support surface. In an alternate method of mounting the arm 100, the clamping member 142 may first be secured to the stationary beam 144 via the sole fastener 145a. With the fastener 145b positioned so that it is not extending across the aperture 140, the main arm 100 may be easily slid along the top of the support surface, so that the rods of the headrest are received within the aperture 140. With the rod closest to the center of the vehicle adjacent the fastener 145a, the main arm 100 is positioned fully on the support surface and the second fastener 145b may be tightened in order to lock the rods within the aperture 140 and fully secure the main arm 100 to the support surface.

Parallel jaw or clamping member 142 and stationary beam 144 have compressible strips 147a,b on their interior sides in order to accommodate slight variations in the diameter of the rods and to provide a tighter clamping force of the main arm 100. In an embodiment, the strip or liner 147a,b is formed of a resilient rubber, polymer or synthetic that both compresses upon abutment, but also provides friction against the rods. In an embodiment, a santoprene liner may be insert molded within the aperture 140 to form the liner 147a,b. In a preferred embodiment, parallel jaw 142 and stationary beam 144, each have a thickness of at least ¾″ in order to provide a wide flat surface to abut the rods when the main arm 100 is fully mounted, to prevent the arm 100 from wobbling or torquing. The extension arms 120 may be quite long (more than 10″) and the weight of the electronic device 115 may exceed 3 pounds. So to avoid vibration, tilting of the entire assembly and diving of the electronic device 115, the main arm 100 should have a clamping force greater than 25 lbs per inch. The main arm aperture 140 has a high clamping force stabilizing area in order to provide a very stable mount. Therefore, it is not necessary to lower the headrest or use a clamping member to hold the arm 100 in a position to offset the weight of an electronic component 115 mounted on the platform 110.

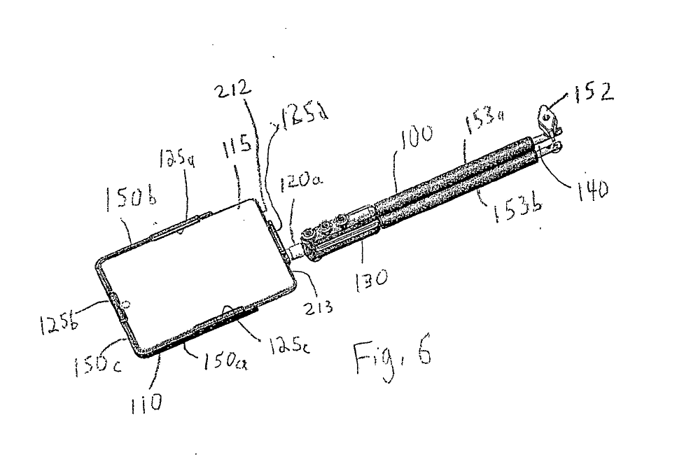

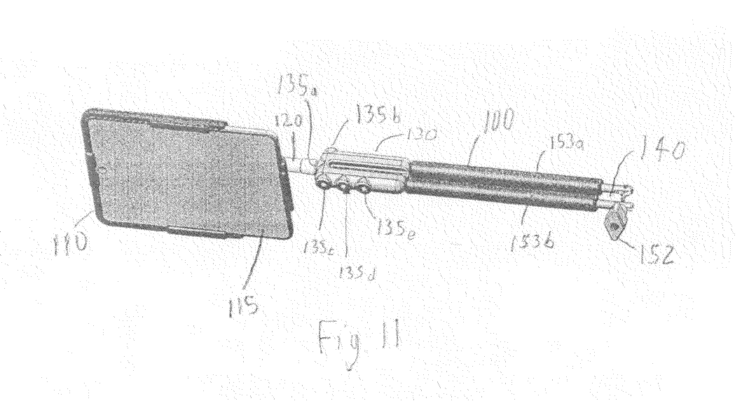

The base or plate 110 further includes attachment members 125a,b,c,d (FIG. 6) which is secured to the platform 110 and helps to securely attach the electronic component 115 to the base 110. In an embodiment, a further attachment member 125e may include elastic straps having hook and loop fasteners, such as Velcro straps that are attached at both sides of the mounting surface 110 (FIG. 10). The straps 81, 82 may be secured to the mounting area, for example by fasteners, adhesive or insert molding.

A rim 150 may be positioned to abut against the edge of the electronic component 115 mounted on the platform 110. Thus, the electronic component 115 is captured between the ridge 150a on one side and the rim 150b on the other side so that the X-Y or lateral movement of the electronic component 115 is restricted by the rim 150a,b.(FIG. 6) In an embodiment, the rim 150 may surround the mounting area 112 on a third side 150c, so that lateral movement is restricted in all directions. Vertical movement or movement in the Z axis is restricted by the retention members 125a,b,c placed around the electronic component 115 as additional means of restricting movement of the electronic component 115, to insure that it cannot come loose during high speed deceleration.

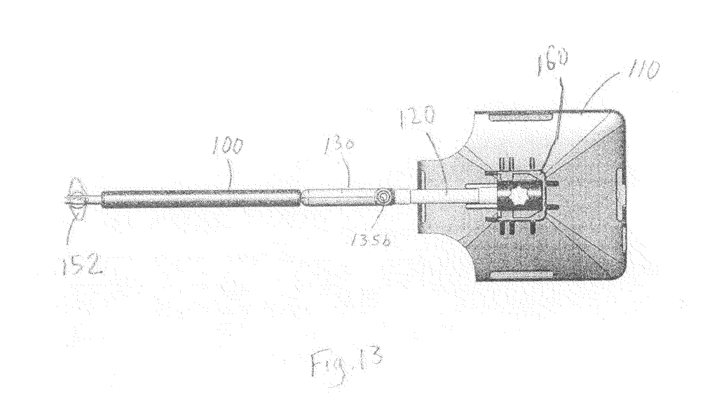

An alternate embodiment is depicted in FIGS. 11-13, that has a single fastener 152 for clamping a pair of tubes 153a,b together when the arm is slid onto rods of a headrest. The tubes 153a,b are insert molded in the junction member 130 which forms a pivot point for each tube 153a,b. Prior to inserting the rods of a headrest within the aperture 140, the fastener 152 is pivoted out of the way so that there is an opening through which the rods can be inserted. After receiving the rods in the aperture 140, the fastener is pivoted to a closed position so that the rods are locked within the aperture 140. The fastener 152, such as a thumb screw is tightened in order to pull the tubes 153a,b toward each other. The tubes 153a,b have rubber or foam pads thereon in order to grip the rods of the headrest as the fastener 152 is tightened in order to firmly support the arm 100 to the support surface.

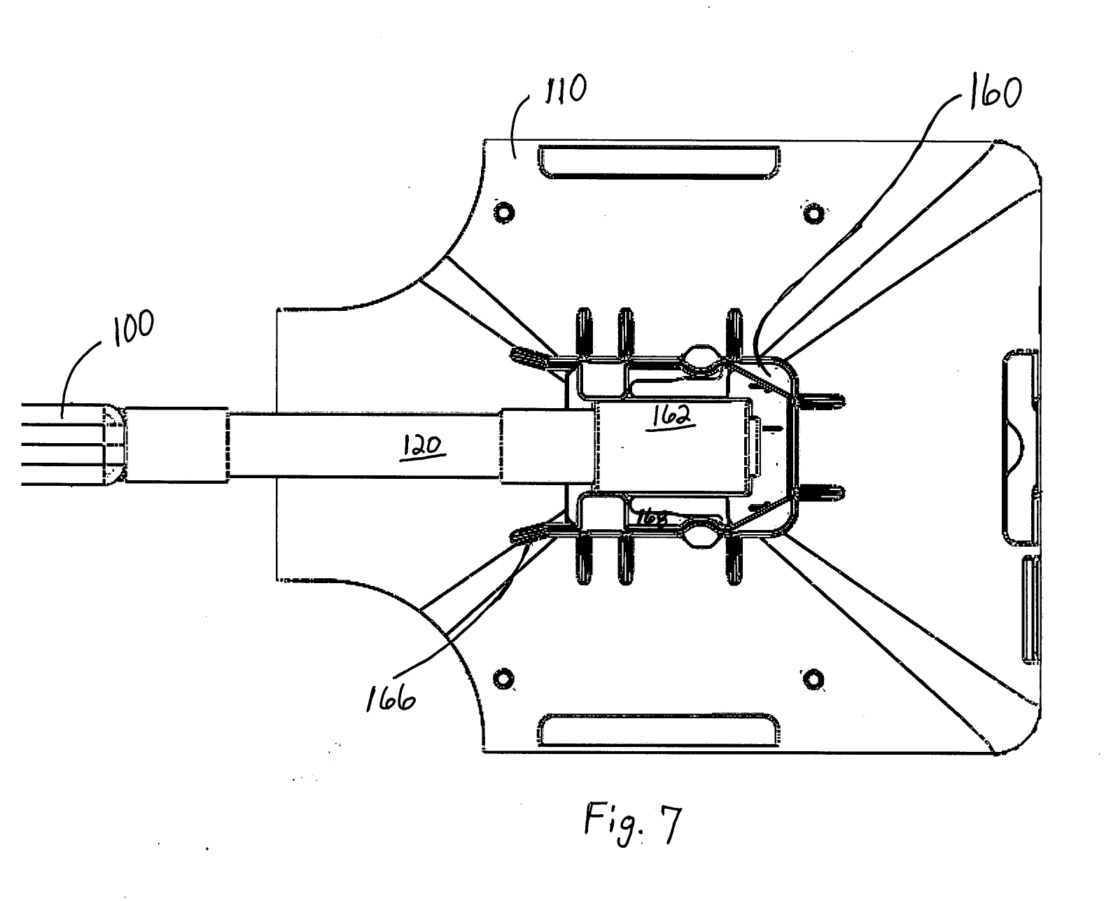

The arm 100, as depicted in FIGS. 11-13, has a single extension arm 120a attached between the main arm 100 and the plate 110. The attachment of the extension 120a is described with respect to FIG. 7.

The mounting arm 100 has internal symmetry that allows it to be rotated so that the arm is located on the other side of a vehicle and mounted to the headrest of the other (passenger) seat. It is also understood that in a vehicle with multiple rows of seats, that the mounting arm may be attached to any seat, in any of the rows. As well, the mounting arm may be used in other vehicles such as boats or airplanes, etc. In a further alternate embodiment the platform may include an arm 100a,b extending from each side of the platform 110 (FIG. 10). Each arm 100a,b may be attached to the interior rod of a first seat and on the opposite side of the vehicle, an interior rod of the second seat. Each arm 100a,b is tethered to the side of the platform 110 via a spring, so that the arms 100a,b may be stretched in opposite directions to reach the adjacent rods of the seats. Each arm 100a,b is rotatably mounted to the side of the platform 110, so that when a tablet computer or other electronic device is mounted, the platform 110 may be rotated at about 90 degrees so that the platform 110 and electronic device are oriented in a generally vertical position so that the screen of the electronic device may be viewed by the passengers of the vehicle. The same platform 110 and assembly may be used for mounting a DVD player or laptop computer having a flip-up screen, where the platform 110 may be positioned in a generally horizontal orientation via rotation of the arms 100a,b.

As shown in FIG. 10, each arm 100a,b includes a pivoting finger 155a,b for clamping onto a rod of a support surface. The arm 100a,b and finger 155a,b have corresponding semi-circle cut-out 156a,b for receiving the rod therein. A toggle 157a,b locks the finger 155a,b in a closed position when toggled to a generally vertical position.

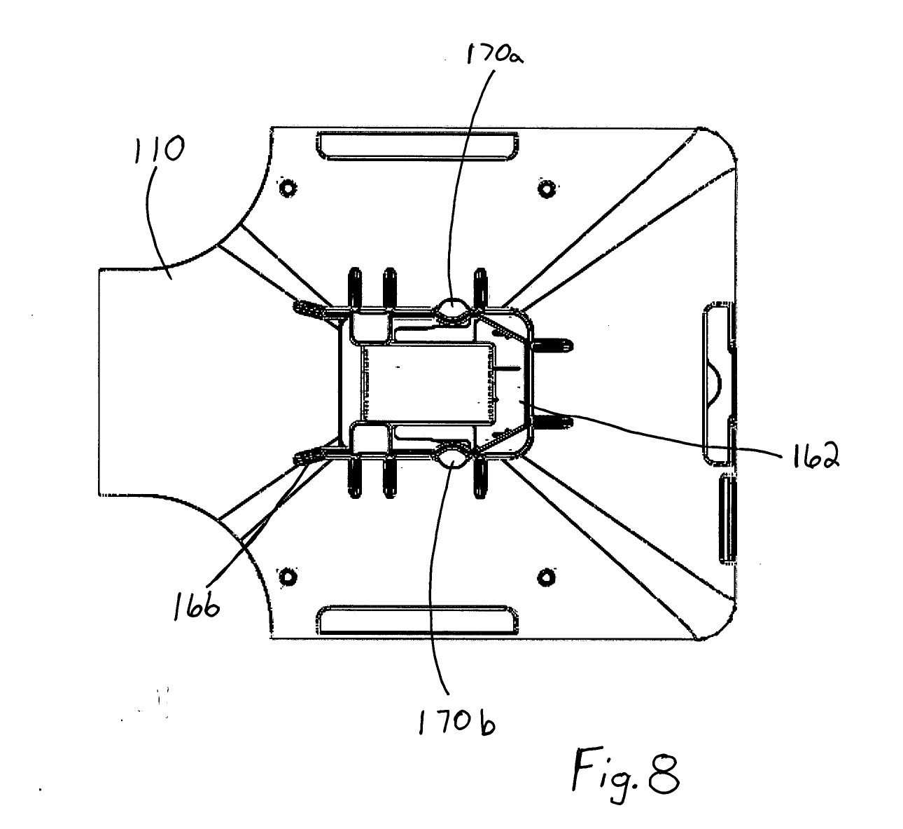

As shown in FIG. 7, the plate 110 includes a mounting bracket 160 on the back side. The bracket 160 slidably receives a sleeve 162 placed at the end of the extension arm 120. The sleeve 162 is secured to the arm 120 via a fastener 164, such as a thumb screw. The bracket 160 includes guide walls 166 for grabbing edges 168 of the sleeve 162. An alternate embodiment is depicted in FIG. 8 where the sleeve 162 includes a pair of resilient spring arms 170a,b on opposite sides of the sleeve 162. The guide walls 166 include apertures for receiving the terminal ends of the spring arms 170a,b. The sleeve 162 may be snap-fit within the mounting bracket 160 when it is slid into a fully mated position where the spring arms 170a,b mate with the apertures in each guide wall 166. The sleeve 162 may be released from the bracket 160 by squeezing the terminal ends of the spring arms 170a,b toward one another to release them from the apertures.

Thus, it may be understood that upon mounting of the arm 100 to a headrest or other mounting device, an electronic device 115 may be mounted to the platform 110 using straps, clamps, fasteners as discussed above. After the electronic device 115 is mounted to the platform 110, the snake arm 120a,b,c,d,e may be manipulated and bent so that the platform 110 is located in a desired position. For example, if the mounting arm 100 is used in a large vehicle with a high ceiling and good rear visibility through the rear view mirror, the snake arm 120 may be extended parallel to the arm 100 so that the platform 110 is located between two (front) seats at the same height as the top of the seat-back or upright members for viewing by passengers in the second row of the vehicle. If the arm 100 is mounted in a vehicle that is a bit smaller and has a generally low ceiling with limited visibility through the rear view mirror; the snake arm 120 may be adjusted vertically and pushed downward so that the platform 110 is lowered below the level of the top of the seat-backs and the screen of the electronic component, when extended, will not block the rear view mirror. As well, the snake arm 120 may be adjusted laterally so that the platform 110 is moved closer to the viewers in the middle and back row of the vehicle. For example, if only one passenger is located in the rear seat, the snake arm 120 may be adjusted so that the platform is located behind the seat to which the mounting arm 100 is mounted and directly in front of the sole passenger. It is to be understood that the mounting arm 100 may also be mounted to the seat-backs of the middle row of a vehicle, such as a mini-van or SUV, so that the passengers in the back row may view the electronic device mounted to the platform 100. Further, using a longer snake arm 120 allows it to be swung toward the front of the vehicle so that the driver can view the electronic device 115 (preferably when the vehicle is stopped). The front passenger may also swing the snake arm 120 forward for viewing of the electronic device 115.

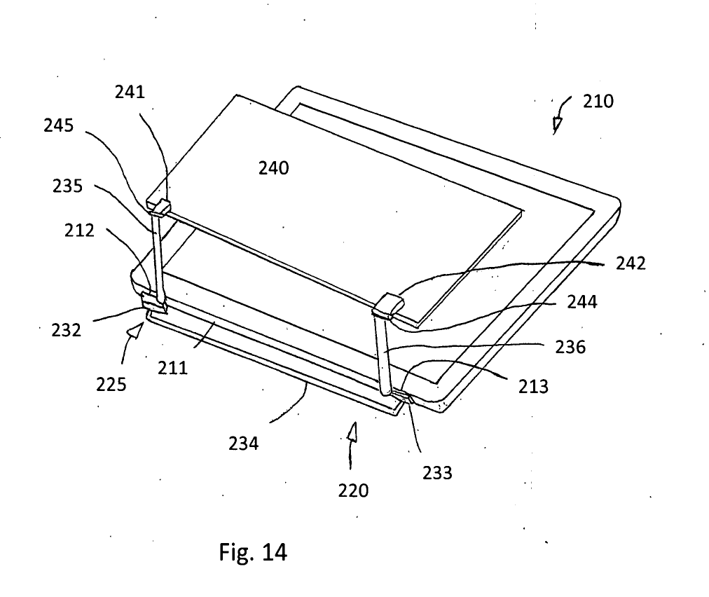

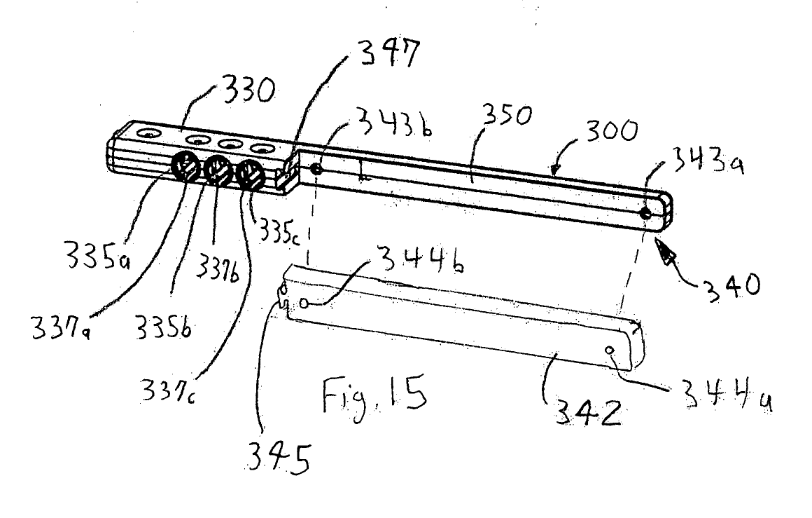

FIG. 14 depicts an accessory for an electronic device such as a tablet computer that may be used when the electronic device is used with the mounting arm of the present invention. A tablet computer 210, such as an Apple iPad or Motorola Xoom is well known and has a touch screen encased in a rectangular shell. The shell has a metal frame 211 with four sides. On at least one side is provided a mounting area. The frame mounting area 211 includes a first locating pad 212 near one corner and a second locating pad 213 near the opposite corner of the tablet 210. The accessory 220 is mounted to the tablet 210 via the locating pads 212, 213. In an embodiment, magnets are used to mount the accessory to the tablet frame 211. In the embodiment depicted in FIG. 14, the accessory is a sun-shade that allows for the tablet computer to be used more easily in bright sun-shine, so that the screen is easier to view. In order that the mounting area 211 is unobstructed, the platform 110 depicted above in FIG. 6, must have gaps formed in the rim 150c, so that the locating pads 212, 213 of the electronic device 110, 210 may be exposed. Also, the retention member 125d may be formed narrowly so that it does not extend over the locating pads 212, 213.

In am embodiment, magnets are provided within the frame 211 at each locating pad 212, 213. The accessory 220 includes metal mounting feet 231, 232 that are attracted by the magnets in the frame 211, so that the feet 232, 233 are mounted at the locating pads 212, 213, respectively. In an alternate embodiment the feet 232, 233 may have magnets embedded therein, so that they are attracted to the metal of the locating pads 212, 213 on the frame 211. Magnets have sufficient force to hold an accessory weighing up to one pound are provided.

The mounting feet 231, 232 are connected by a tie rod 234. The tie rod 234 and the mounting feet 231, 232 comprise a attachment strut 225. The present invention comprises the attachment strut for a variety of accessories. While the attachment points to the attachment strut 225 may vary with respect to each different type of accessory being provided, the attachment strut 225 may remain as a consistent component.

As shown in FIG. 14, a pair of struts 235, 236 extend from the attachment strut 225. A sun shade 240 is attached to the struts 235, 236 via prongs 241, 242. In an embodiment, the prongs 241, 242 are pivotally mounted via pivot rods 244, 245 to the struts 235, 236. The prongs 241, 242 may be attached to the shade 40 using adhesive or fasteners. The struts 235, 236 may also be attached to the feet 231,232 in a swiveling manner so that the struts 235, 236 may move in many orientations in order to allow the shade 240 to be manipulated in multiple orientations. In an embodiment, the shade 240 may be any lightweight material such as nylon, cotton, plastic or cardboard. The dimensions of the shade 240 may be equal to the dimensions of the underlying screen of the tablet 210 below, slightly larger or slightly smaller.

Other types of accessories that may be attached to the attachment strut 225 include a tablet cover, game cover, tablet stand, cable routing sleeve, game handle, remote holder, wireless link holder, screen protector, vehicle mount, protective case and screen cleaner. For example, a game cover may provide for a modifiable cover that exposes and covers particular parts of the screen in coordination with a game application that is programmed to interact with the customized game cover, such as a Hangman game where the cover is used to hide the word being guessed to fill in the blanks before the hangman is completed.

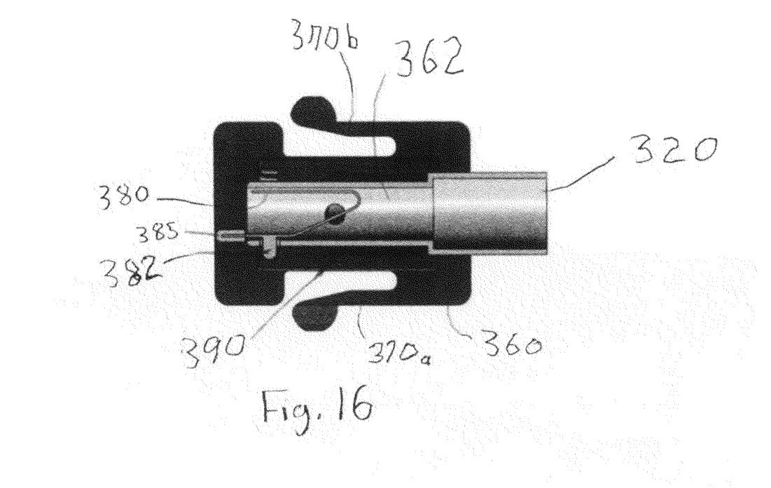

Turning to FIG. 15, a main mounting arm 300 is depicted having a junction member 330 integrally formed at a first end. The junction member 330 includes mounting points 335 a, b, c. Additional mounting points 335d and e are present, but not depicted as they are present at the terminal end of the junction member 330. Each of the mounting points 335 a, b, c includes a female receptacle 337 a, b, c for receiving extension arms as discussed previously. In an embodiment the extension arms include ferrules which are snap-fit into the female receptacles 337 a, b, c. Alternate means of securing the extension arms within the female receptacles 337 a, b, c may also be provided. For example, the extension may have a male ferrule which is threaded so that it may be screwed within the female receptacles 337 a, b, c.

A clamping member 342 is an elongate rectangular piece which may be fitted onto the second end of the main mounting arm 300. The clamping member 342 includes a T member 345 that is inserted into the T slot 347 of the main mounting arm 300. The insertion of the T member 345 into the T slot 347 provides for stability of the clamping member 342 when it is attached to the main mounting arm 300 and stabilizes the clamping member 342 when fully secured to the main mounting arm 300. The clamping member 342 includes fastening holes 344 a, b which mate with the fastening holes of the main mounting arm 343 a, b. As discussed above, the holes 343 a, b and 344, a, b may receive fastening members to help clamp the clamping member 342 around rods 61, 62 in order to secure the main mounting arm 30 thereto. In an embodiment, the main mounting arm 300 may have a rubberized surface 350 for engaging the rods 61, 62 as discussed above. An aperture 340 is formed between the clamping member 342 and main mounting arm 300 for receiving the rods 61, 62 therein.

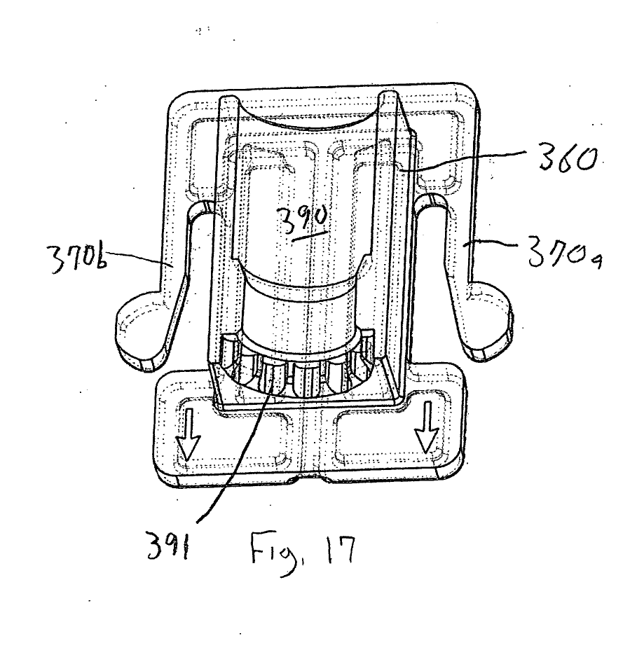

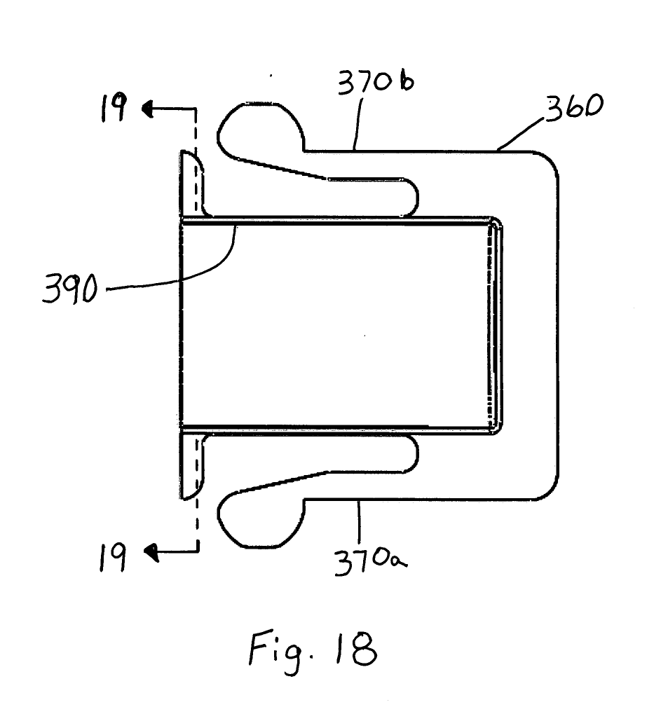

FIG. 16 depicts a mounting bracket 360 which is attached to the plate support area that holds the electronic component. In this embodiment, the bracket 360 includes a pair of spring arms 370 a, b so that the bracket 360 may be slid into a receiving aperture of the plate as discussed above. Once the bracket 360 is attached to the plate, an extension arm 320 having a sleeve 362 at its terminal end may be inserted into a bore 390 of the bracket 360. The sleeve 362 may be secured in many fashions within the bore 390.

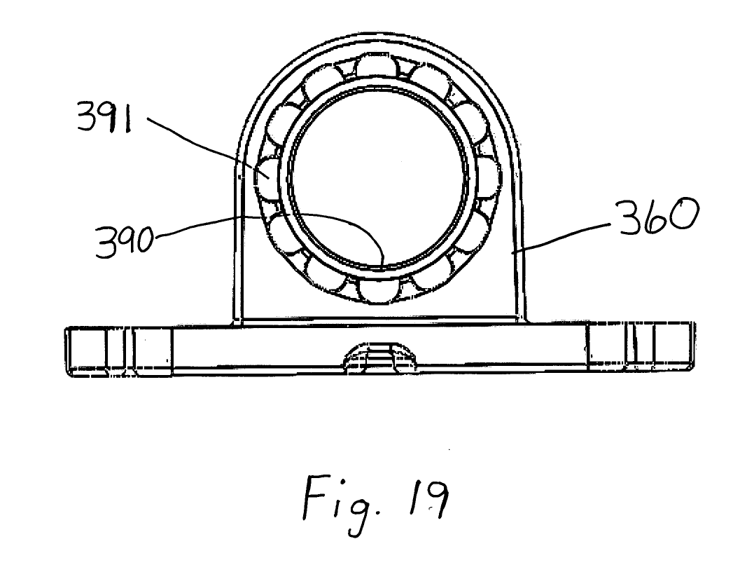

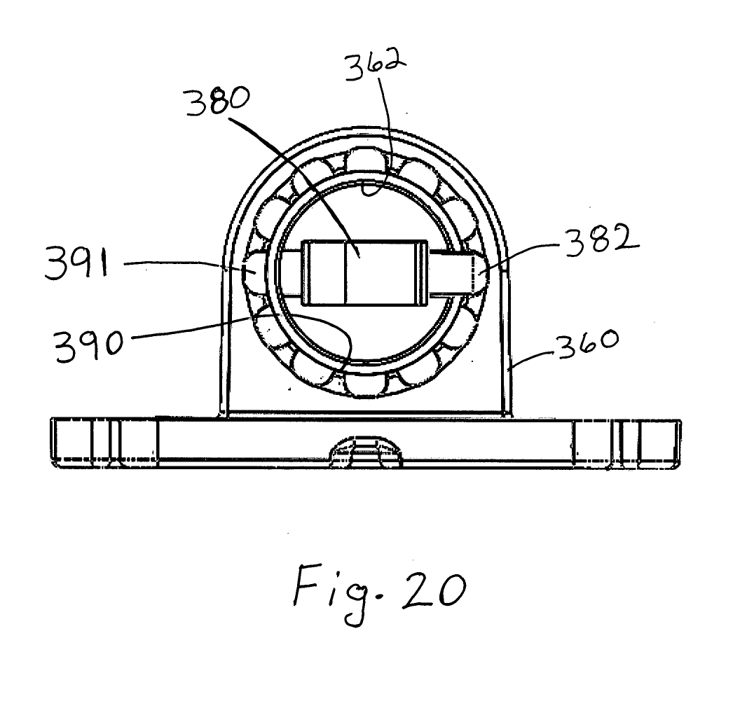

In an embodiment, the bore includes gear serrations 391 as depicted in FIGS. 17, 19 and 20. Each of the figures will be discussed together. The sleeve 362 includes a spring clip 380 which is mounted within a channel of the sleeve 362. The spring clip 380 includes a tooth 382 that protrudes through a hole in the sleeve 362. When the plate is attached to the bracket 360, the bracket 360 is slid over the sleeve 362 and a person can hold the plate and rotate the plate to adjust the plate to a preferable orientation so that the electronic component mounted on the plate is in an ideal viewing position. While the plate is being rotated, the bracket 360 which is attached thereto also rotates and the tooth 382 is freely movable within the bore 390. When the desired position and orientation of the plate is obtained, the bracket 360 is pushed an extra quarter of an inch onto the sleeve 360 so that the two 380 registers in one of the gear serrations 390. The registration of the tooth 382 within the gear serration 390 will lock the bracket 360 in the desired orientation. In this way, the plate and electronic component mounted thereto can easily be adjusted at the end of the extension arm 320, so that it may be viewed in its optimum position. When it is desired that the electronic component on the plate be removed from the end of the extension arm 320, there are two alternatives. The person operating the unit may grab the spring arms 370 a, b between his thumb and finger in order to release the bracket 360 from the plate. By depressing the spring arms 370 a, b, the bracket 360 can be removed from the slot of the plate so that the plate is removed from the end of the extension arm 320. Alternatively, the extension arm 320 may be removed from the bore 390 by depressing the release lever 385 and the sleeve 362 may be slid from the end of the bore 390. Thereby removing the plate and the electronic component mounted thereon from the end of the extension arm 320.

The matters set forth in the foregoing description and accompanying drawings is offered by way of illustration only and not as a limitation. While particular embodiments have been shown and described, it will be apparent to those skilled in the art that the changes and modifications may be made without departing from the broader aspects of applicant's contribution. The actual scope of the protection site is intended to be defined in the claims when viewed in their proper perspective based on the prior art.

For example, the arm 100 may be attached to any rod or sturdy member extending from any surface such as a hospital bed, dentist chair, stand, office rack, bicycle, exercise equipment, boat surface, lecturn, courtroom furniture or outdoor furniture. In other words, any place where one can use a tablet computer or other portable electronic device, the arm 100 of the present invention, including each of its many embodiments may be attached in a horizontal, vertical or other orientation so that the plate 110 may be extended therefrom and oriented/swung into position for viewing of the screen of the electronic device mounted thereon in the users environment of choice.

What is claimed:

1. Arm for mounting an electronic component comprising:
a. an arm including a launch to no access and a mounting aperture formed along the longitudinal axis, the arm having a junction member having at least two mounting points;
b. a support area for receiving the electronic component thereon, the support area attached to the arm at the first mounting point;
c. an attachment member for fastening at least a portion of the electronic component to the support area;
d. an upright member having a rod that extends from a support surface; a and
e. the arm mounted so that the rod of the upright members disposed inside the mounting aperture.

2. The arm of claim 1 wherein the arm includes a slot to stabilize and receive a T member of a clamping member.

3. The arm of claim 1 wherein the two mounting points include female receptacles for receiving male ferrules of an extension arm.

4. The arm of claim 1 wherein the support area includes a bracket mounted thereto.

5. The bracket of claim 4 wherein the bracket includes a bore including gear serrations located around the inner diameter of the bore.

6. The mounting bracket of claim 5 wherein the gear serrations receive a tooth extending from a spring clip attached to the end of an extension arm.

7. The mounting bracket of claim 6 wherein the bracket and plate are selectively adjustable on the extension arm and upon orienting the bracket in the desired position, the tooth may positively engage a gear serration of the bracket in order to secure the bracket in the desired orientation.

8. The arm of claim 1 wherein the junction member includes at least four mounting points.

9. The arm of claim 1 wherein the junction member includes at least five mounting points.

10. The arm of claim 1 wherein an extension arm is attached to a mounting point of the junction member and the extension arm being flexible in multiple orientations.

11. The arm of claim 9 wherein the extension arm is metallic and includes spring members.

12. The arm of claim 10 wherein the extension arm is a goose-neck type flexible cylindrical rod.

13. The arm of claim 1 wherein the extension arm includes a release lever in order to release the extension arm from the bracket.

14. The arm of claim 12 where in the bracket includes a pair of spring arms in order to allow for the bracket to be snap-fit within a sleeve of the support area.

15. An arm for mounting electronic component comprising;
a. a main mounting arm including a junction member having at least two mounting points;
b. a plate for receiving an electronic component thereon; the plate attached to the main mounting arm at a first mounting point;
c. an extension arm extending from the mounting point of the junction member at a first end and a second end of the extension arm attached to the plate via a tooth and gear serration assembly.

16. The arm of claim 15 wherein the plate includes a bracket having a bore and an inner diameter of the bore including gear serrations for receiving a tooth extending from the second end of the extension arm.

17. The arm of claim 15 wherein a spring clip is mounted to the second end of the extension member and the spring clip including a tooth.

18. The arm of claim 17 wherein the tooth extends into a hole in the second end of the extension arm and the tooth movable between a first engaged position and a second released position.

19. The arm of claim 15 further comprising a clamping member attached to the main mounting arm and an aperture formed between the clamping member and main mounting arm.

20. the arm of claim 19 wherein the aperture is capable of receiving a rod of a headrest of a vehicle therein.
